(19) United States
(12) Patent Application Publication
(10) Pub. No.: US 2026/0169858 A1
(43) Pub. Date: Jun. 18, 2026

(54) OPTIMIZING SMMU CONTEXT SAVE AND RESTORE

(71) Applicant: QUALCOMM Incorporated, San Diego, CA (US)

(72) Inventors: Subham PANDA, Balasore (IN); Swostik ACHARYA, Bhubaneswar (IN); Radhakrishna MUGADA, Hyderabad (IN); Nileshkumar CHANDRAKANTBHAI MOTAWALA, Surat (IN)

(21) Appl. No.: 18/981,315

(22) Filed: Dec. 13, 2024

(51) Int. Cl. G06F 11/14; G06F 21/60

(52) U.S. Cl. CPC G06F 11/1435; G06F 11/1417; G06F 21/602

(57) ABSTRACT

A system is provided for an SMMU context save process in which only the configuration registers whose contents are changed following an SMMU initialization are saved to a system memory. Similarly, the system performs an SMMU context restore by only writing to the configuration registers whose context had changed prior to the SMMU context save process.

### TECHNICAL FIELD

The present application relates generally to a system memory management unit (SMMU), and more particularly to optimizing an SMMU context save and restore in a system including a system main memory.

### BACKGROUND

System-on-a-chip (SoC) devices may include one or more processors, coupled through a bus to one or more client devices (e.g., input/output devices). It is convenient for the client devices to address a system main memory such as a double data rate (DDR) dynamic random-access memory (DRAM) without the memory access passing through the processor(s) in what is denoted as a direct memory access. A system memory management unit (SMMU) assists in this direct memory access (DMA) by translating virtual addresses for DMA from the client devices into physical addresses for addressing the DDR DRAM. An SMMU is configured to perform this translation using memory-mapped configuration registers that define how the virtual-to-physical address translation should occur and also manage the access control.

The SMMU's configuration registers map to a corresponding region in the system's main memory. To define how virtual addresses are translated, the configuration registers include registers that define a page table base address. The page tables are the structures that map virtual addresses into physical addresses. A configuration register denoted as a translation register stores the corresponding page table base address. In addition, configuration registers configure the page table formats and also the context bank configuration. An SMMU will typically have multiple context banks, with each context bank being assigned to a corresponding client device or address space. To configure the context banks, the configuration registers point to page tables for address translation for a given context bank and also define various permissions and attributes. There are a variety of other configuration registers such as for configuring the translation lookaside buffer (TLB), managing interrupts and faults, and so on.

It may thus be appreciated that the configuration register space or storage for an SMMU is relatively large. At power-up of the system, the SMMU performs an initialization procedure in which the configuration registers are either reset or set to some default configuration. During subsequent operation, the configuration registers then store the SMMU context that is developed as the client devices perform SMMU transactions with the main memory. Should the system then enter a deep sleep state or perform a quick boot, the SMMU context should then be saved in the main memory such as the DDR DRAM so that the SMMU context may be restored when the system reboots or leaves the deep sleep state. But traditional systems such as those with ARM architectures cannot identify whether a configuration register has been changed during normal operation. It is thus conventional to back up the entire configuration register space prior to entering a deep sleep state or a quick boot by writing the contents of the configuration registers to the main memory. But the large configuration register space causes the resulting backup of the SMMU context to consume an appreciable amount of time, which slows system operation by delaying the transition to a non-retention state for the configuration registers. The delay also increases power consumption. A similar delay occurs upon the restoration of the SMMU context following a termination of the non-retention state and a resumption of normal operation.

### SUMMARY

In accordance with an aspect of the disclosure, a method of saving a system memory management unit (SMMU) context for a system is a provided that includes: initializing a stored content of a plurality of configuration registers for the SMMU; identifying a subset of the plurality of configuration registers whose stored content has changed during a monitoring period that begins following the initializing and ends at a start of a transition of the system to a non-retention state in which the stored content for the plurality of configuration registers is lost; and writing a content of the subset of the plurality of configuration registers to an SMMU image in a system memory after an end of the monitoring period.

In accordance with another aspect of the disclosure, a system is provided that includes an at least one processor configured to: initialize a stored content of a plurality of configuration registers for an SMMU; identify a subset of the plurality of configuration registers whose stored content has changed during a monitoring period that begins following an initialization of the plurality of configuration registers and ends at a start of a transition of the system to a non-retention state in which stored content for the plurality of configuration registers is lost; and write a content of the subset of the plurality of configuration registers to an SMMU image in a system memory after the end of the monitoring period.

Finally, in accordance with yet another aspect of the disclosure, a system is provided that includes: a system memory; a system memory management unit (SMMU) including a plurality of configuration registers; and an SMMU driver configured to set a bit in each register in a subset of the plurality of configuration registers whose stored content has changed during a monitoring period that begins following an initialization of the plurality of configuration registers and ends at a start of a transition of the system to a non-retention state in which the stored content for the plurality of configuration registers is lost, wherein the SMMU driver is further configured to write a content of the subset of the plurality of configuration registers to an SMMU image in the system memory after an end of the monitoring period.

These and other advantageous features may be better appreciated through the following detailed description.

### BRIEF DESCRIPTION OF THE DRAWINGS

FIG. 1 illustrates a system having an improved SMMU context backup and restore process in which the SMMU's configuration registers include a dirty bit field to identify whether the registers have their stored contents changed during a monitoring period extending from an initialization of the configuration registers to a start of a transition to a deep sleep state or a quick boot in accordance with an aspect of the disclosure.

FIG. 2 illustrates a system having an improved SMMU context backup and restore process in which the SMMU's configuration registers are not modified to identify whether the registers have their stored contents changed during a monitoring period extending from an initialization of the configuration registers to a start of a transition to a deep sleep state or a quick boot in accordance with an aspect of the disclosure.

FIG. 3 is a flowchart for an example method of saving an SMMU context in accordance with an aspect of the disclosure.

FIG. 4 illustrates an example computer system that is configured to practice the SMMU context and store disclosed herein in accordance with an aspect of the disclosure.

Implementations of the present disclosure and their advantages are best understood by referring to the detailed description that follows. It should be appreciated that like reference numerals are used to identify like elements illustrated in one or more of the figures.

### DETAILED DESCRIPTION

A system is provided with an improved SMMU context save and restore process that speeds up both the save of the SMMU context prior to a transition to a non-retention state for a plurality of SMMU configuration registers and the restore of the SMMU context to the plurality of SMMU configuration registers. In the following discussion the transition to a deep sleep state or to a quick boot are examples of transitions to a non-retention state in which the configuration registers lose their stored contents, but it will be appreciated that the improved system disclosed herein is applicable to any transition in which the configuration registers lose their data retention. To reduce the delay of saving the SMMU context prior to a transition to a non-retention state, a system such as a system-on-a-chip (SoC) is disclosed having an improved SMMU context save process in which the system does not back up the entire configuration register space prior to a transition to the non-retention state. Instead, the system backs up only those configuration registers whose stored contents were changed during a monitoring period that extends from an SMMU initialization of the configuration registers to a start of a transition to the non-retention state. Similarly, an improved system is disclosed that reduces the delay of restoring the SMMU context following a transition from the non-retention state to normal operation.

At the end of the monitoring period the system identifies the configuration registers (e.g., global configuration registers and context bank specific registers) whose stored content has changed due to client SMMU transactions changing the SMMU context. The system then updates an SMMU image in the main memory with the contents of the changed configuration registers. Since a portion of the configuration registers will typically be unchanged during the monitoring period despite the change in the SMMU context, the updating of the backup is relatively fast as compared to the traditional copying of the entire configuration register space to the DDR DRAM prior to the deep sleep state (which may also be denoted as a deep sleep mode) or prior to performing a quick boot. Similarly, since the SMMU image contains only the data from the changed configuration registers, a latency in restoring the SMMU context following an SMMU initialization at the end of the non-retention state is reduced because only those configuration registers that were changed are written to during the restore process. Following the restoration of the SMMU context, normal operation may resume.

There are two main implementations disclosed herein with respect to the SMMU identifying the configuration registers whose stored contents have been modified during the monitoring period. In these implementations, the non-retention state occurs from a transition to a deep sleep state or a quick boot, but it will be appreciated that the improved SMMU context save and restore disclosed herein is widely applicable to any transition in which the SMMU's configuration registers lose their stored state (lose their retention). In a first implementation, not only is the system software modified but a subset of the configuration registers is modified to include a bit field that identifies whether the configuration registers have been updated during the monitoring period. Should the bit field be a single bit wide, an SMMU driver changes a binary state of a reserved bit within specific ones of the registers relating to the changed SMMU context to identify those registers that have had their stored contents modified during the monitoring period. The reserved bit may also be denoted herein as a “dirty bit” since it flags whether the corresponding configuration register has had a change in its stored contents during the monitoring period. At the end of the monitoring period for a transition to the deep sleep state, the SMMU enters a deep sleep entry sequence during which the SMMU driver (or a hypervisor) copies the contents of the changed SMMU registers as flagged by their dirty bits to the SMMU image file in the main memory such a DDR DRAM (note that the DDR DRAM may actually be a plurality of DDR DRAMs having a unified memory mapping but will be referred to herein as a single DDR DRAM for brevity). The remaining unmodified configuration registers are not copied into the SMMU image during the transition to the deep sleep state. A similar update of the SMMU image is performed prior to performing a quick boot.

In a second implementation, the improved SMMU context and restore is performed using software only without any hardware modifications. In the second implementation, the configuration registers are unmodified (no usage being made of their reserved bits). To monitor which of the configuration registers have had their stored contents modified during the monitoring period, a hypervisor (or the SMMU driver) writes to a metadata region in the DDR DRAM. For example, the metadata region may include a bit field having a corresponding bit for each of the monitored configuration registers during the monitoring period. Should a client perform an SMMU transaction that results in a change in the SMMU context, the SMMU updates the corresponding configuration register(s). In addition, the hypervisor (or the SMMU driver) sets the bits in the metadata bit field corresponding to the changed configuration registers to flag that that the configuration registers have had their contents changed. Before entering deep sleep (or quick boot), the hypervisor reads the metadata bit field to identify those configuration registers having a changed stored content since the SMMU initialization. Should a metadata bit be set for a configuration register to indicate that its stored contents are changed, the hypervisor copies the stored content of the configuration register to the SMMU image in the main memory. Upon exiting the non-retention state, the configuration registers again are initialized according to the SMMU initialization process. The hypervisor then copies the SMMU image to the corresponding configuration registers so that the SMMU context may be restored. Note that the entire configuration register space is not restored but instead the hypervisor writes only to those configuration registers that will be storing the restored SMMU context.

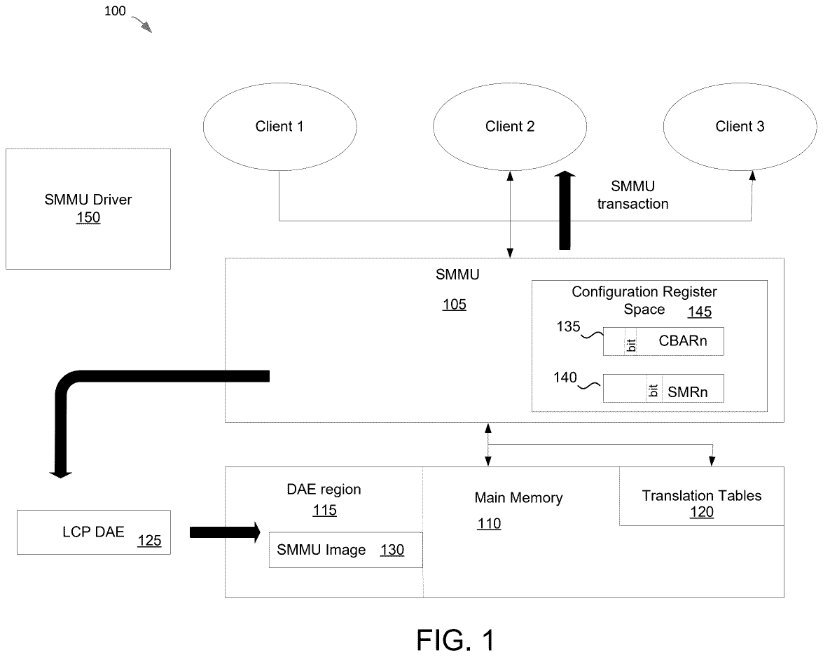

The first implementation will now be discussed in more detail followed by a discussion of the second implementation. An example system 100 is shown in FIG. 1. A plurality of client devices (e.g., a Client 1, a Client 2, and a Client 3) have their direct memory access to a main memory 110 (e.g., a DDR DRAM) managed by an SMMU 105. At an initialization of the SMMU 105 such as at power-up of the system 100, an SMMU driver 150 initializes the entire configuration register space 145. In the SMMU initialization, each configuration register may be reset or written to with a default value. After the SMMU initialization, at least one of the clients engages in one or more SMMU transactions that alters the contents of the configuration register space 145 (the SMMU context being changed or altered). This change in the configuration register space 105 may occur with respect to an nth context bank as managed by a corresponding nth context bank address register CBARn 135, where n is a positive integer identifying the corresponding context bank for the SMMU transaction. Similarly, the SMMU transaction may also change the contents of a nth stream ID register SMRn 140, where the nth stream ID relates to the address translation context for the SMMU transaction. To flag this change in the SMMU context, the SMMU driver 150 sets a dirty bit in any of the CBARn registers 135 that have had their stored contents changed during the monitoring period. Similarly, the SMMU driver 150 sets a dirty bit in any of the SMRn registers 140 that have had their stored contents changed during the monitoring period.

At the end of the monitoring period, the SMMU driver 150 reads the dirty bit field for the CBARn registers 135 and for the SMRn registers 140 and writes the contents of the changed registers to an SMMU image 130 in the main memory 110. In the following discussion, it will be assumed that the SMMU image 130 is written to a data encryption and authentication (DAE) region 115 within the main memory 110 such as through a last level cache controller (LLC) co-processor (LCP) 125 but it will be appreciated that the SMMU image 130 may be unencrypted in alternative implementations. The encryption of the SMMU image 130 is advantageous with respect to securing it from a hostile party or agent while the system 100 is suspended such as in a deep sleep state or in a power off mode. In contrast, should the SMMU image 130 be stored in the main memory 110 without encryption, its contents are vulnerable to any threats which can corrupt the SMMU image 130 to then cause a crash during wakeup or warm boot of the system 100. The SMMU image 130 may also be coded for error correction to protect against bit flips in the main memory 110 such as due to high temperatures. Note that the content of any unchanged registers in the configuration register space 145 is not written to the SMMU image 130 at the end of the monitoring period since SMMU image 130 is updated only with the contents of the changed configurations registers. A transition delay or latency from the end of the monitoring period to a deep sleep state or a quick boot is thus advantageously reduced, thereby saving power and increasing the operating speed of system 100.

At the end of the non-retention period, the configuration register space 145 is again initialized through another SMMU initialization. The SMU driver 150 (or a hypervisor) may then restore the SMMU context by copying the SMMU image back to the corresponding configuration registers in the configuration register space 145. Note that this restoration does not need to write to the entire space 145 but only to those configuration registers that are necessary for restoring the SMMU context. The delay or latency for the restoration of the SMMU context following a resumption of normal operation from the non-retention state is thus advantageously reduced. In contrast, a traditional SMMU context restoration would use an SMMU image 130 that is the same size as the configuration register space 145 because the traditional restoration had no way of identifying configuration registers whose contents are changed following an SMMU initialization.

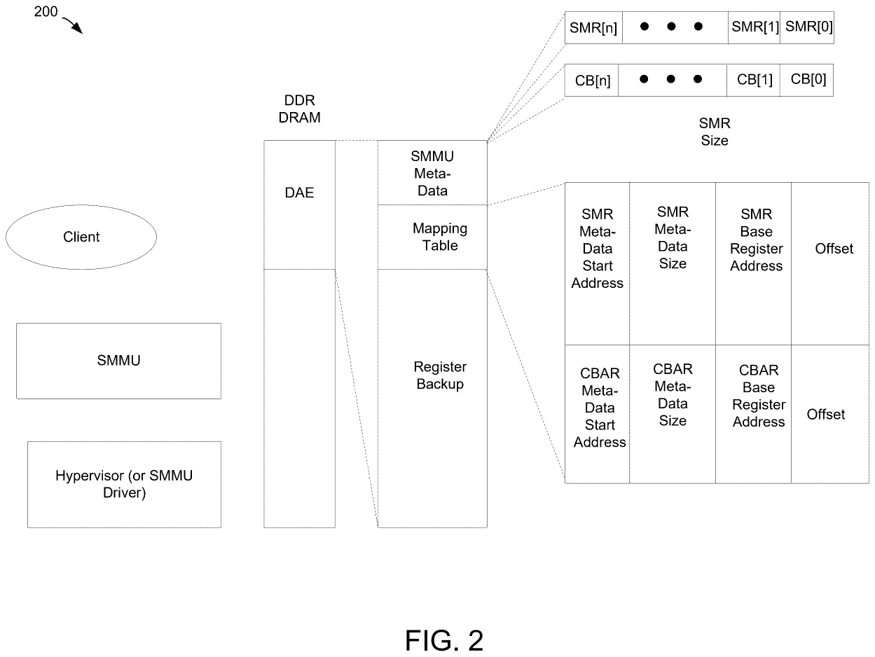

A system 200 for the second implementation is shown in FIG. 2. For illustration clarity, only a single client is shown in system 200 but it will be appreciated that a plurality of clients may be serviced by the SMMU in the system 200. A DDR DRAM has its DAE region expanded to show that the DAE region may include an SMMU metadata region and a mapping table. The SMMU metadata region includes an SMR register bit field that includes a dirty bit for each of n stream ID registers (SMRs) ranging from a zeroth bit for a zeroth SMR to an nth bit for an nth SMR. Similarly, the SMMU metadata region includes a context bank address register (CBAR) bit field that includes a dirty bit for each of n context bank registers ranging from a zeroth bit for a zeroth CBAR to an nth bit for an nth CBAR. It will be appreciated that the dirty bit field may be a multi-bit field for each CBAR and SMR in alternative implementations. Whenever a client performs an SMMU transaction that changes the SMMU context during the monitoring period, the corresponding CBAR or SMR is updated accordingly. In conjunction with this configuration register update, a hypervisor (or an SMMU driver) sets the corresponding dirty bit(s) in the DAE region of the DDR DRAM to ensure that the SMMU update is authenticated and encrypted. Prior to entering a deep sleep state or beginning a quick boot, the monitoring period ends whereupon the hypervisor reads the DAE metadata to identify the changed context bank address registers and changed stream ID registers through their dirty bits being set (note that is arbitrary whether a dirty bit is set thorough an active-high or an active-low convention). Should a dirty bit be set, the hypervisor reads the corresponding configuration register so that its contents may be written to the SMMU image in the DAE region of the DDR. The SMMU image thus includes only the stored content of the changed configuration registers. In contrast, a traditional SMMU context save would write the entire configuration register space to the main memory since a traditional SMMU context save procedure has no way of identifying whether a configuration register has changed since an SMMU initialization.

To identify the dirty bit fields, the DAE region may include a mapping table that includes a start address of the SMR dirty bit field and a size of the SMR dirty bit field. Similarly, the mapping table may include a start address of the SMR dirty bit field and a size of the SMR dirty bit field. In this fashion, the hypervisor may read the mapping table to then be able to read the dirty bit fields. In addition, the mapping table may include a SMR base register address and offset as well as a CBAR base register address and offset for the register back in the DDR DRAM so that the hypervisor may locate and retrieve the changed configuration register data from the register backup. Through these mappings, the hypervisor may locate and read the configuration registers for which the metadata had set dirty bits. During a SMMU context restore following a termination of the non-retention state for the configuration registers, the hypervisor reads the mapping table so it may then read the SMR and CBR data in the register backup. The hypervisor then writes the SMR and CBR data back to the corresponding registers following another SMMU initialization at a resumption of normal operation subsequent to a termination of the non-retention state. As discussed with regard to the first implementation, the resulting SMMU context restoration takes less time as compared to a traditional SMMU context restoration.

Regardless of whether a register is modified to include a dirty bit field as discussed for the first implementation or whether the changed configuration registers are monitored through software alone as discussed for the second implementation, the resulting update of the SMMU image in the DDR main memory is quite advantageous because the system may track the modified configuration registers and retain only the stored content of the modified configuration registers. The resulting SMMU image in the main memory thus has a reduced size as compared to storing the entire configuration register space in the main memory. Similarly, the improved SMMU context restoration reduces the latency from deep sleep and from a quick boot since the entire configuration register space need not be retrieved from the main memory. In addition, the improved SMMU context save and restore may enhance security by saving the SMMU image in an encrypted and authenticated portion of the main memory.

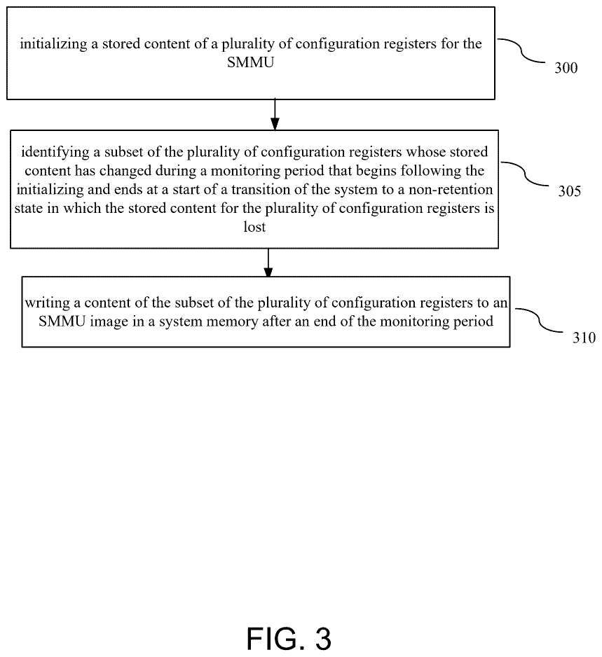

A method of saving an SMMU context will now be discussed with respect to the flowchart of FIG. 3. The method includes an act 300 of initializing a stored content of a plurality of configuration registers for the SMMU. The initialization of each configuration register in the configuration register space 145 in system 100 of for each configuration register of the SMMU in system 200 is an example of act 300. The method further includes an act 305 of identifying a subset of the plurality of configuration registers whose stored content has changed during a monitoring period that begins following the initializing and ends at a start of a transition of the system to a non-retention state in which the stored content for the plurality of configuration registers is lost. The identification of the changed registers through a reserved bit field as discussed with respect to system 100 or through a system memory metadata as discussed with regard to system 200 is an example of act 305. Finally, the method includes an act 310 of writing a content of the subset of the plurality of configuration registers to an SMMU image in a system memory after an end of the monitoring period. The writing of the SMMU image to the main memory 110 as discussed for system 100 or to the DDR of system 200 is an example of act 310.

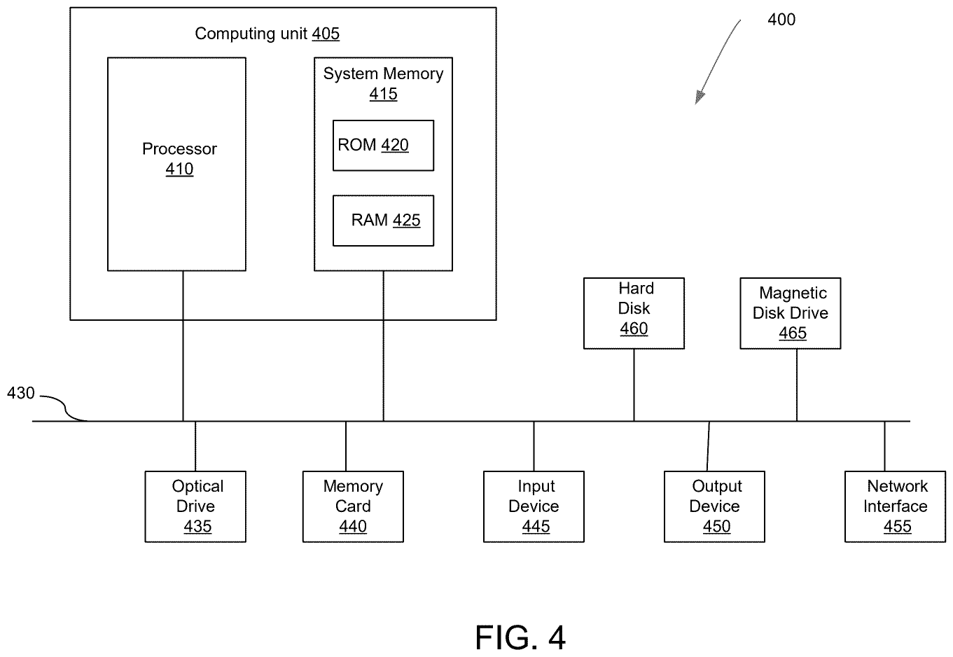

Any suitable computing system may be used to implement the SMMU context and restore disclosed herein. An example computing system 400 that may be programmed to implement the SMMU context save and restore is shown in FIG. 4. As seen in this figure, the computing system 400 includes a computing unit 405 with an at least one processor 410 that executes instructions from and stores data in a system memory 415. The at least one processor 410 may be any type of programmable electronic device for executing software instructions but will typically be one or more microprocessors. The system memory 415 may include both a read-only memory (ROM) 420 and a random-access memory (RAM) 425. As will be appreciated by those of ordinary skill in the art, both the read-only memory (ROM) 420 and the random-access memory (RAM) 425 may store software instructions for execution by the at least one processor 410.

The at least one processor 410 and the system memory 415 are connected, either directly or indirectly, through a bus 430 or alternate communication structure, to one or more peripheral devices. For example, the at least one processor 410 or the system memory 415 may be directly or indirectly connected to one or more additional memory storage devices, such as a “hard” magnetic disk drive 460, a removable magnetic disk drive 465, an optical disk drive 435, or a flash memory card 440. The at least one processor 410 and the system memory 415 also may be directly or indirectly connected to one or more input devices 445 and one or more output devices 450. The input devices 445 may include, for example, a keyboard, a pointing device (such as a mouse, touchpad, stylus, trackball, or joystick), a scanner, a camera, and a microphone. The output devices 445 may include, for example, a monitor display, a printer and speakers. With various examples of the computer system 400, one or more of the peripheral devices 435, 440, 445, 460, and 465 may be internally housed within a housing of the computer system 400. Alternately, one or more of the peripheral devices 435, 440, 445, 460, and 465 may be external to the housing and connected to the bus 430 through, for example, a Universal Serial Bus (USB) connection.

With some implementations, the computing system 400 may be directly or indirectly connected to one or more network interfaces 455 for communicating with other devices making up a network. The network interface 455 translates data and control signals from the computer system 400 into network messages according to one or more communication protocols, such as the transmission control protocol (TCP) and the Internet protocol (IP). Also, the interface 455 may employ any suitable connection agent (or combination of agents) for connecting to a network, including, for example, a wireless transceiver, a modem, or an Ethernet connection. Such network interfaces and protocols are well known in the art, and thus will not be discussed here in more detail. It should be appreciated that the computing system 400 is illustrated as an example only, and it not intended to be limiting. Various implementations may be formed using one or more computing systems that include the components of the system 400 illustrated in FIG. 4 or which include only a subset of the components illustrated in FIG. 4, or which include an alternate combination of components, including components that are not shown in FIG. 4.

Some example implementations will now be summarized through the following numbered clauses:

Clause 1. A method of saving a system memory management unit (SMMU) context for a system, comprising:
initializing a stored content of a plurality of configuration registers for the SMMU;
identifying a subset of the plurality of configuration registers whose stored content has changed during a monitoring period that begins following the initializing and ends at a start of a transition of the system to a non-retention state in which the stored content for the plurality of configuration registers is lost; and
writing a content of the subset of the plurality of configuration registers to an SMMU image in a system memory after an end of the monitoring period.

Clause 2. The method of clause 1, further comprising encrypting the SMMU image prior to writing the SMMU image to the system memory.

Clause 3. The method of clause 2, wherein writing the SMMU image to the system memory comprises writing the SMMU image to a data authentication and encryption portion of the system memory.

Clause 4. The method of any of clauses 1-3, further comprising:
entering the non-retention state;
reinitializing the stored content of the plurality of configuration registers following a termination of the non-retention state; and
recovering the SMMU context following reinitializing by copying the SMMU image from the system memory to the subset of the plurality of configuration registers.

Clause 5. The method of clause 4, wherein identifying the subset of the plurality of configuration registers comprises setting a bit in a reserved bit field in each register in a plurality of context bank address registers.

Clause 6. The method of clause 5, wherein recovering the SMMU context comprises retrieving the SMMU image from the system memory and writing a retrieved SMMU image to the plurality of context bank address registers.

Clause 7. The method of clause 4, wherein identifying the subset of the plurality of configuration registers comprises setting a bit in a reserved field in each register in a plurality of stream ID registers.

Clause 8. The method of clause 3, wherein identifying the subset of the plurality of configuration registers comprises setting a corresponding bit for each configuration register in the subset of the plurality of configurations registers in a metadata field in the system memory.

Clause 9. The method of clause 8, wherein the subset of the plurality of configuration registers comprises a plurality of context bank address registers and a plurality of stream ID registers.

Clause 10. A system including an at least one processor in a system including a system memory management unit (SMMU) context, wherein the at least one processor is configured to:
initialize a stored content of a plurality of configuration registers for the SMMU;
identify a subset of the plurality of configuration registers whose stored content has changed during a monitoring period that begins following an initialization of the plurality of configuration registers and ends at a start of a transition of the system to a non-retention state in which stored content for the plurality of configuration registers is lost; and
write a content of the subset of the plurality of configuration registers to an SMMU image in a system memory after the end of the monitoring period.

Clause 11. The system of clause 10, wherein the at least one processor is further configured to encrypt the SMMU image prior to writing the SMMU image to the system memory.

Clause 12. The system of clause 11, wherein the system memory is a double data rate dynamic random-access memory (DDR DRAM).

Clause 13. The system of clause 12, wherein the at least one processor is further configured to write the SMMU image to a data authentication and encryption portion of the DDR DRAM.

Clause 14. The system of any of clauses 10-13, wherein the at least one processor is further configured to:
reinitialize the stored content of the plurality of configuration registers following a termination of the non-retention state; and
recover the SMMU context following a reinitialization of the plurality of configuration registers by a write of the SMMU image to the subset of the plurality of configuration registers.

Clause 15. The system of any of clauses 10-13, wherein the at least one processor is further configured to identify the subset of the plurality of configuration registers through a read of a bit in a reserved bit field from each register in a plurality of context bank address registers and in a plurality of stream ID registers.

Clause 16. The system of any of clauses 10-13, wherein the at least one processor is further configured to identify the subset of the plurality of configuration registers through a read of corresponding bits in a metadata field register in the system memory.

Clause 17. a System Comprising:
a system memory;
a system memory management unit (SMMU) including a plurality of configuration registers; and
an SMMU driver configured to set a bit in each register in a subset of the plurality of configuration registers whose stored content has changed during a monitoring period that begins following an initialization of the plurality of configuration registers and ends at a start of a transition of the system to a non-retention state in which the stored content for the plurality of configuration registers is lost, wherein the SMMU driver is further configured to write a content of the subset of the plurality of configuration registers to an SMMU image in the system memory after an end of the monitoring period.

Clause 18. The system of clause 17, wherein the SMMU driver is further configured to encrypt the SMMU image before the SMMU image is written to the system memory.

Clause 19. The system of clause 18, wherein the system memory is a DDR DRAM having a data authentication and encryption region for a storage of the SMMU image.

Clause 20. The system of any of clauses 17-19, wherein the subset of the plurality of configuration registers comprises a subset of context bank address registers and a plurality of stream ID registers.

As those of some skill in this art will by now appreciate and depending on the particular application at hand, many modifications, substitutions and variations can be made in and to the materials, apparatus, configurations and methods of use of the devices of the present disclosure without departing from the scope thereof as defined by the appended claims. In light of this, the scope of the present disclosure should not be limited to that of the particular implementations illustrated and described herein, as they are merely by way of some examples thereof, but rather, should be fully commensurate with that of the claims appended hereafter and their functional equivalents.

What is claimed is:

1. A method of saving a system memory management unit (SMMU) context for a system, comprising:
initializing a stored content of a plurality of configuration registers for the SMMU;
identifying a subset of the plurality of configuration registers whose stored content has changed during a monitoring period that begins following the initializing and ends at a start of a transition of the system to a non-retention state in which the stored content for the plurality of configuration registers is lost; and
writing a content of the subset of the plurality of configuration registers to an SMMU image in a system memory after an end of the monitoring period.

2. The method of claim 1, further comprising encrypting the SMMU image prior to writing the SMMU image to the system memory.

3. The method of claim 2, wherein writing the SMMU image to the system memory comprises writing the SMMU image to a data authentication and encryption portion of the system memory.

4. The method of claim 1, further comprising:
entering the non-retention state;
reinitializing the stored content of the plurality of configuration registers following a termination of the non-retention state; and
recovering the SMMU context following reinitializing by copying the SMMU image from the system memory to the subset of the plurality of configuration registers.

5. The method of claim 4, wherein identifying the subset of the plurality of configuration registers comprises setting a bit in a reserved bit field in each register in a plurality of context bank address registers.

6. The method of claim 5, wherein recovering the SMMU context comprises retrieving the SMMU image from the system memory and writing a retrieved SMMU image to the plurality of context bank address registers.

7. The method of claim 4, wherein identifying the subset of the plurality of configuration registers comprises setting a bit in a reserved field in each register in a plurality of stream ID registers.

8. The method of claim 3, wherein identifying the subset of the plurality of configuration registers comprises setting a corresponding bit for each configuration register in the subset of the plurality of configurations registers in a metadata field in the system memory.

9. The method of claim 8, wherein the subset of the plurality of configuration registers comprises a plurality of context bank address registers and a plurality of stream ID registers.

10. A system having an at least one processor that is configured to:
initialize a stored content of a plurality of configuration registers for an SMMU;
identify a subset of the plurality of configuration registers whose stored content has changed during a monitoring period that begins following an initialization of the plurality of configuration registers and ends at a start of a transition of the system to a non-retention state in which stored content for the plurality of configuration registers is lost; and
write a content of the subset of the plurality of configuration registers to an SMMU image in a system memory after the end of the monitoring period.

11. The system of claim 10, wherein the at least one processor is further configured to encrypt the SMMU image prior to writing the SMMU image to the system memory.

12. The system of claim 11, wherein the system memory is a double data rate dynamic random-access memory (DDR DRAM).

13. The system of claim 12, wherein the at least one processor is further configured to write the SMMU image to a data authentication and encryption portion of the DDR DRAM.

14. The system of claim 10, wherein the at least one processor is further configured to:
reinitialize the stored content of the plurality of configuration registers following a termination of the non-retention state; and
recover the SMMU context following a reinitialization of the plurality of configuration registers by a write of the SMMU image to the subset of the plurality of configuration registers.

15. The system of claim 10, wherein the at least one processor is further configured to identify the subset of the plurality of configuration registers through a read of a bit in a reserved bit field from each register in a plurality of context bank address registers and in a plurality of stream ID registers.

16. The system of claim 10, wherein the at least one processor is further configured to identify the subset of the plurality of configuration registers through a read of corresponding bits in a metadata field register in the system memory.

17. A system comprising:
a system memory;
a system memory management unit (SMMU) including a plurality of configuration registers; and
an SMMU driver configured to set a bit in each register in a subset of the plurality of configuration registers whose stored content has changed during a monitoring period that begins following an initialization of the plurality of configuration registers and ends at a start of a transition of the system to a non-retention state in which the stored content for the plurality of configuration registers is lost, wherein the SMMU driver is further configured to write a content of the subset of the plurality of configuration registers to an SMMU image in the system memory after an end of the monitoring period.

18. The system of claim 17, wherein the SMMU driver is further configured to encrypt the SMMU image before the SMMU image is written to the system memory.

19. The system of claim 18, wherein the system memory is a DDR DRAM having a data authentication and encryption region for a storage of the SMMU image.

20. The system of claim 17, wherein the subset of the plurality of configuration registers comprises a subset of context bank address registers and a plurality of stream ID registers.
